(19) United States
(12) Patent Application Publication
(10) Pub. No.: US 2026/0136243 A1
(43) Pub. Date: May 14, 2026

(54) INTER CELL BEAM MANAGEMENT MODE AND LOWER LAYER MOBILITY

(71) Applicant: Nokia Technologies Oy, Espoo (FI)

(72) Inventors: Ali KARIMIDEHKORDI, Munich (DE); Panagiotis SPAPIS, Munich (DE); Ahmad AWADA, Munich (DE); Halit Murat GÜRSU, Munich (DE); Timo KOSKELA, Oulu (FI); Umur KARABULUT, Munich (DE)

(21) Appl. No.: 19/111,654

(22) PCT Filed: Sep. 6, 2023
(86) PCT No.: PCT/EP2023/074449

§ 371 Date: Mar. 13, 2025

(30) Foreign Application Priority Data
Sep. 28, 2022 (GB) 2214176.6

(51) Int. Cl. H04W 36/00; H04B 7/06; H04W 36/08

(52) U.S. Cl. CPC H04W 36/0058; H04B 7/06952; H04W 36/085

(57) ABSTRACT

An apparatus comprises means for receiving measurement report information provided by a communications device, the communications device using a beam associated with a cell of a target node while being connected to a source node, means for determining based on the measurement report that the communications device is to change cell to a target cell of the target node, and means for causing information to be provided to the communications device of a cell change to the target cell.

### FIELD

The present application relates to methods, apparatus, systems and computer programs and in particular but not exclusively to methods, apparatus, systems and computer programs relating to cell change.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communications devices.

In a wireless communication system at least a part of a communication session between at least two stations occurs over a wireless link. Examples of wireless systems comprise public land mobile networks (PLMN), satellite-based communication systems and different wireless local networks, for example wireless local area networks (WLAN). Some wireless systems can be divided into cells and are therefore often referred to as cellular systems.

A user equipment (UE) moving through the network infrastructure of a mobile communication network with its radio access network faces varying radio conditions. To maintain an ongoing service and connectivity, a UE is handed-over to another base station or radio cell when moving away from the coverage area of its current base station or cell.

### SUMMARY

According to one aspect, there is provided a method comprising: receiving measurement report information provided by a communications device, the communications device using a beam associated with a cell of a target node while being connected to a source node; determining based on the measurement report that the communications device is to change cell to a target cell of the target node or another target node; and causing information to be provided to the communications device of a cell change to the target cell.

Th measurement report may comprise an L1 measurement report.

The information provided to the communications device may comprise an indication of a lower layer mobility.

The method may comprise receiving, from a central unit, lower layer mobility configuration information.

The method may comprise causing information about the determining to be provided to a central unit.

The receiving may comprise receiving the measurement report information from the communications device in the target node.

The determining may comprise determining, in the target node, that the communications device is to change cell.

The causing information to be provided to the communications device may comprise causing that information to be transmitted from the target node to the communications device.

The receiving may comprise receiving the measurement report information from the communications device in the target node, the determining may comprise determining in the target node that the communications device is to change cell, and the causing information to be provided to the communications device may comprise causing that information to be transmitted from the target node to the communications device.

The method may be performed by an apparatus. The apparatus may be in or provided by the target node.

The receiving may comprise receiving the measurement report information, from a control unit or target node, in the source node, and the determining may comprise determining in the source node that the communications device is to change cell.

The receiving may comprise receiving the measurement report information, from a control unit or target node, in the source node.

The determining may comprise determining in the source node that the communications device is to change cell.

The causing information to be provided to the communications device may comprise causing that information to be provided to the communications device via the target node.

The method may be performed by an apparatus. The apparatus may be in or provided by the source node.

The receiving may comprise receiving the measurement report information, from the target node, in a central unit, and the determining may comprise determining in the central unit that the communications device is to change cell.

The receiving may comprise receiving the measurement report information, from the target node, in a central unit.

The determining may comprise determining in the central unit that the communications device is to change cell.

The causing information to be provided to the communications device may comprise causing that information to be provided to the communications device via the target node.

The method may be performed by an apparatus. The apparatus may be in or provided by central unit.

The communications device when using a beam associated with a target cell while being connected to a source cell may be operating in an inter cell beam management mode.

The target node and the source node may be distributed units of a radio access node.

The radio access network node may comprise the central unit.

According to another aspect, there is provided an apparatus comprising: means for receiving measurement report information provided by a communications device, the communications device using a beam associated with a cell of a target node while being connected to a source node; means for determining based on the measurement report that the communications device is to change cell to a target cell of the target node or another target node; and means for causing information to be provided to the communications device of a cell change to the target cell.

The measurement report may comprise an L1 measurement report.

The information provided to the communications device may comprise an indication of a lower layer mobility.

The apparatus may comprise means for receiving, from a central unit, lower layer mobility configuration information.

The apparatus may comprise means for causing information about the determining to be provided to a central unit.

The receiving means may be for receiving the measurement report information from the communications device in the target node.

The determining means may be for determining, in the target node, that the communications device is to change cell.

The means for causing information to be provided to the communications device may be for causing that information to be transmitted from the target node to the communications device.

The receiving means may be for receiving the measurement report information from the communications device in the target node, the determining means may be for determining in the target node that the communications device is to change cell, and the means for causing information to be provided to the communications device may be for causing that information to be transmitted from the target node to the communications device.

The apparatus may be in or provided by the target node.

The receiving means may be for receiving the measurement report information, from a control unit or target node, in the source node, and the determining means may be for determining in the source node that the communications device is to change cell.

The receiving means may be for receiving the measurement report information, from a control unit or target node, in the source node.

The determining means may be for determining in the source node that the communications device is to change cell.

The means for causing information to be provided to the communications device may be for causing that information to be provided to the communications device via the target node. The apparatus may be in or provided by the source node.

The receiving means may be for receiving the measurement report information, from the target node, in a central unit, and the determining means may be for determining in the central unit that the communications device is to change cell

The receiving means may be for receiving the measurement report information, from the target node, in a central unit.

The determining means may be for determining in the central unit that the communications device is to change cell

The means for causing information to be provided to the communications device may be for causing that information to be provided to the communications device via the target node.

The apparatus may be in or provided by central unit.

The communications device when using a beam associated with a target cell while being connected to a source cell may be operating in an inter cell beam management mode.

The target node and the source node may be distributed units of a radio access node.

The radio access network node may comprise the central unit.

According to another aspect, there is provided an apparatus comprising circuitry configured to: receive measurement report information provided by a communications device, the communications device using a beam associated with a cell of a target node while being connected to a source node; determine based on the measurement report that the communications device is to change cell to a target cell of the target node or another target node; and cause information to be provided to the communications device of a cell change to the target cell.

The measurement report may comprise an L1 measurement report.

The information provided to the communications device may comprise an indication of a lower layer mobility.

The circuitry may be configured to receive, from a central unit, lower layer mobility configuration information.

The circuitry may be configured to cause information about the determining to be provided to a central unit.

The circuitry may be configured to receive the measurement report information from the communications device in the target node.

The circuitry may be configured to determine, in the target node, that the communications device is to change cell.

The circuitry may be configured to cause the information to be transmitted from the target node to the communications device.

The circuitry may be configured to receive the measurement report information from the communications device in the target node, to determine in the target node that the communications device is to change cell, and to cause the information to be transmitted from the target node to the communications device.

The apparatus may be in or provided by the target node.

The circuitry may be configured to receive the measurement report information, from a control unit or target node, in the source node, and to determine in the source node that the communications device is to change cell.

The circuitry may be configured to receive the measurement report information, from a control unit or target node, in the source node.

The circuitry may be configured to determine in the source node that the communications device is to change cell.

The circuitry may be configured to cause the information to be provided to the communications device via the target node.

The apparatus may be in or provided by the source node.

The circuitry may be configured to receive the measurement report information, from the target node, in a central unit, and to determine in the central unit that the communications device is to change cell.

The circuitry may be configured to receive the measurement report information, from the target node, in a central unit.

The circuitry may be configured to determine in the central unit that the communications device is to change cell.

The circuitry may be configured to cause the information to be provided to the communications device via the target node.

The apparatus may be in or provided by central unit.

The communications device when using a beam associated with a target cell while being connected to a source cell may be operating in an inter cell beam management mode.

The target node and the source node may be distributed units of a radio access node.

The radio access network node may comprise the central unit.

According to another aspect, there is provided an apparatus comprising at least one processor and at least one memory storing instructions that, when executed by the at least one processor cause the apparatus at least to: receive measurement report information provided by a communications device, the communications device using a beam associated with a cell of a target node while being connected to a source node; determine based on the measurement report that the communications device is to change cell to a target cell of the target node or another target node; and cause information to be provided to the communications device of a cell change to the target cell.

The measurement report may comprise an L1 measurement report.

The information provided to the communications device may comprise an indication of a lower layer mobility.

The apparatus may be caused to receive, from a central unit, lower layer mobility configuration information.

The apparatus may be caused to cause information about the determining to be provided to a central unit.

The apparatus may be caused to receive the measurement report information from the communications device in the target node.

The apparatus may be caused to determine, in the target node, that the communications device is to change cell.

The apparatus may be caused to cause the information to be transmitted from the target node to the communications device.

The apparatus may be caused to receive the measurement report information from the communications device in the target node, to determine in the target node that the communications device is to change cell, and to cause the information to be transmitted from the target node to the communications device.

The apparatus may be in or provided by the target node.

The apparatus may be caused to receive the measurement report information, from a control unit or target node, in the source node, and to determine in the source node that the communications device is to change cell.

The apparatus may be caused to receive the measurement report information, from a control unit or target node, in the source node.

The apparatus may be caused to determine in the source node that the communications device is to change cell.

The apparatus may be caused to cause the information to be provided to the communications device via the target node.

The apparatus may be in or provided by the source node.

The apparatus may be caused to receive the measurement report information, from the target node, in a central unit, and to determine in the central unit that the communications device is to change cell.

The apparatus may be caused to receive the measurement report information, from the target node, in a central unit.

The apparatus may be caused to determine in the central unit that the communications device is to change cell.

The apparatus may be caused to cause the information to be provided to the communications device via the target node.

The apparatus may be in or provided by central unit.

The communications device when using a beam associated with a target cell while being connected to a source cell may be operating in an inter cell beam management mode.

The target node and the source node may be distributed units of a radio access node.

The radio access network node may comprise the central unit.

According to another aspect, there is provided a method comprising: causing a measurement report to be transmitted from a communications device, the communications device using a beam associated with a cell of a target node while being connected to a source node; and receiving in response to the measurement report, information indicating that the communications device is to be change cell to a target cell of the target node.

The measurement report may comprise an L1 measurement report.

The information received by the communications device may comprises an indication of a lower layer mobility.

The communications device when using a beam associated with a target cell while being connected to a source cell may be operating in an inter cell beam management mode.

The method may comprise providing information to a network node indicating that the communications device is configured to support switching from an inter cell beam management mode operation to a lower layer mobility cell change operation without disconnecting inter cell beam management mode operation.

The method may comprise providing information to a network node indicating that the communications device is configured to support coexistence of inter cell beam management and lower layer mobility.

The method may be performed by an apparatus. The apparatus may be in or be the communications device.

According to another aspect, there is provided an apparatus comprising: means for causing a measurement report to be transmitted from a communications device, the communications device using a beam associated with a cell of a target node while being connected to a source node; and means for receiving in response to the measurement report, information indicating that the communications device is to be change cell to a target cell of the target node.

The measurement report may comprise an L1 measurement report.

The information received by the communications device may comprises an indication of a lower layer mobility.

The communications device when using a beam associated with a target cell while being connected to a source cell may be operating in an inter cell beam management mode.

The apparatus may comprise means for providing information to a network node indicating that the communications device is configured to support switching from an inter cell beam management mode operation to a lower layer mobility cell change operation without disconnecting inter cell beam management mode operation.

The apparatus may comprise means for providing information to a network node indicating that the communications device is configured to support coexistence of inter cell beam management and lower layer mobility.

The apparatus may be in or be the communications device.

According to another aspect, there is provided an apparatus comprising circuitry configured to: cause a measurement report to be transmitted from a communications device, the communications device using a beam associated with a cell of a target node while being connected to a source node; and receive in response to the measurement report, information indicating that the communications device is to be change cell to a target cell of the target node.

The measurement report may comprise an L1 measurement report.

The information received by the communications device may comprises an indication of a lower layer mobility.

The communications device when using a beam associated with a target cell while being connected to a source cell may be operating in an inter cell beam management mode.

The circuitry may be configured to provide information to a network node indicating that the communications device is configured to support switching from an inter cell beam management mode operation to a lower layer mobility cell change operation without disconnecting inter cell beam management mode operation.

The circuitry may be configured to provide information to a network node indicating that the communications device is configured to support coexistence of inter cell beam management and lower layer mobility.

The apparatus may be in or be the communications device.

According to another aspect, there is provided an apparatus comprising at least one processor and at least one memory storing instructions that, when executed by the at least one processor cause the apparatus at least to: cause a measurement report to be transmitted from a communications device, the communications device using a beam associated with a cell of a target node while being connected to a source node; and receive in response to the measurement report, information indicating that the communications device is to be change cell to a target cell of the target node.

The measurement report may comprise an L1 measurement report.

The information received by the communications device may comprises an indication of a lower layer mobility.

The communications device when using a beam associated with a target cell while being connected to a source cell may be operating in an inter cell beam management mode.

The apparatus may be caused to provide information to a network node indicating that the communications device is configured to support switching from an inter cell beam management mode operation to a lower layer mobility cell change operation without disconnecting inter cell beam management mode operation.

The apparatus may be caused to provide information to a network node indicating that the communications device is configured to support coexistence of inter cell beam management and lower layer mobility.

The apparatus may be in or be the communications device.

According to another aspect, there is provided a method comprising: configuring, by a central unit, a target node or a source node to make a lower layer mobility decision for a user equipment which using a beam associated with a cell of a target node while being connected to a source node

The configuring may comprise causing a configuration message to be provided to the respective one of the target node and source node

The method may comprise configuring by the central unit, a target node, to forward a lower layer mobility report to be used for a lower layer mobility cell change decision for a user equipment which is using a beam associated with a cell of a target node while being connected to a source node

The method may comprise configuring the target node to forward the lower layer mobility report to the central unit or the source node.

The method may comprise forwarding by the control unit the measurement report to the source node.

The method may comprise configuring, by the central unit, the source node to notify the central unit or the target node about a lower layer mobility cell change decision.

The method may comprise forwarding a lower layer mobility cell change decision received from the source node to the target node.

The method may be performed by an apparatus. The apparatus may be in or provided by the central unit.

According to another aspect, there is provided an apparatus comprising: means for configuring, by a central unit, a target node or a source node to make a lower layer mobility decision for a user equipment which using a beam associated with a cell of a target node while being connected to a source node

The configuring may comprise causing a configuration message to be provided to the respective one of the target node and source node

The apparatus may comprise means for configuring a target node, to forward a lower layer mobility report to be used for a lower layer mobility cell change decision for a user equipment which is using a beam associated with a cell of a target node while being connected to a source node

The apparatus may comprise means for configuring the target node to forward the lower layer mobility report to the central unit or the source node.

The apparatus may comprise means for forwarding by the central unit the measurement report to the source node.

The apparatus may comprise means for configuring, by the central unit, the source node to notify the central unit or the target node about a lower layer mobility cell change decision.

The apparatus may comprise means for forwarding a lower layer mobility cell change decision received from the source node to the target node.

The apparatus may be in or provided by the central unit.

According to another aspect, there is provided an apparatus comprising circuitry configured to: configure, by a central unit, a target node or a source node to make a lower layer mobility decision for a user equipment which using a beam associated with a cell of a target node while being connected to a source node

The configuring may comprise causing a configuration message to be provided to the respective one of the target node and source node

The circuitry may be configured to configure a target node, to forward a lower layer mobility report to be used for a lower layer mobility cell change decision for a user equipment which is using a beam associated with a cell of a target node while being connected to a source node

The circuitry may be configured to configure the target node to forward the lower layer mobility report to the central unit or the source node.

The circuitry may be configured to forward by the central unit the measurement report to the source node.

The circuitry may be configured to configure the source node to notify the central unit or the target node about a lower layer mobility cell change decision.

The circuitry may be configured to forward a lower layer mobility cell change decision received from the source node to the target node.

The apparatus may be in or provided by the central unit.

According to another aspect, there is provided an apparatus comprising at least one processor and at least one memory storing instructions that, when executed by the at least one processor cause the apparatus at least to: configure, by a central unit, a target node or a source node to make a lower layer mobility decision for a user equipment which using a beam associated with a cell of a target node while being connected to a source node

The configuring may comprise causing a configuration message to be provided to the respective one of the target node and source node

The apparatus may be caused to configure a target node, to forward a lower layer mobility report to be used for a lower layer mobility cell change decision for a user equipment which is using a beam associated with a cell of a target node while being connected to a source node

The apparatus may be caused to configure the target node to forward the lower layer mobility report to the central unit or the source node.

The apparatus may be caused to forward by the central unit the measurement report to the source node.

The apparatus may be caused to configure the source node to notify the central unit or the target node about a lower layer mobility cell change decision.

The circuitry may be configured to forward a lower layer mobility cell change decision received from the source node to the target node.

The apparatus may be in or provided by the central unit.

According to another aspect, there is provided a method comprising: configuring by a central unit, a target node, to forward a lower layer mobility report to be used for a lower layer mobility cell change decision for a user equipment which is using a beam associated with a cell of a target node while being connected to a source node.

The method may comprise configuring the target node to forward the lower layer mobility report to the central unit or the source node.

The method may comprise forwarding by the control unit the measurement report to the source node.

The method may comprise configuring, by the central unit, the source node to notify the central unit or the target node about a lower layer mobility cell change decision.

The method may comprise forwarding a lower layer mobility cell change decision from the source node to the target node.

The method may be performed by an apparatus. The apparatus may be in or provided by the central unit.

According to another aspect, there is provided an apparatus comprising: means for configuring by a central unit, a target node, to forward a lower layer mobility report to be used for a lower layer mobility cell change decision for a user equipment which is using a beam associated with a cell of a target node while being connected to a source node.

The configuring may comprise configuring the target node to forward the lower layer mobility report to the central unit or the source node.

The apparatus may comprise means for forwarding by the control unit the measurement report to the source node.

The apparatus may comprise means for configuring the source node to notify the central unit or the target node about a lower layer mobility cell change decision.

The apparatus may comprise means for forwarding a lower layer mobility cell change decision from the source node to the target node.

The apparatus may be in or provided by the central unit.

According to another aspect, there is provided an apparatus comprising circuitry configured to: configure by a central unit, a target node, to forward a lower layer mobility report to be used for a lower layer mobility cell change decision for a user equipment which is using a beam associated with a cell of a target node while being connected to a source node. The configuring may comprise configuring the target node to forward the lower layer mobility report to the central unit or the source node.

The circuity may be configured to forward the measurement report to the source node.

The circuity may be configured to configure the source node to notify the central unit or the target node about a lower layer mobility cell change decision.

The circuity may be configured to forward a lower layer mobility cell change decision from the source node to the target node.

The apparatus may be in or provided by the central unit.

According to another aspect, there is provided an apparatus comprising at least one processor and at least one memory storing instructions that, when executed by the at least one processor cause the apparatus at least to: configure by a central unit, a target node, to forward a lower layer mobility report to be used for a lower layer mobility cell change decision for a user equipment which is using a beam associated with a cell of a target node while being connected to a source node.

The configuring may comprise configuring the target node to forward the lower layer mobility report to the central unit or the source node.

The apparatus may be caused to forward the measurement report to the source node.

The apparatus may be caused to configure the source node to notify the central unit or the target node about a lower layer mobility cell change decision.

The apparatus may be caused to forward a lower layer mobility cell change decision from the source node to the target node.

The apparatus may be in or provided by the central unit.

According to a further aspect, there is provided a computer program comprising instructions, which when executed by the apparatus, cause the apparatus to perform any of the methods set out previously.

According to a further aspect, there is provided a computer program comprising instructions, which when executed cause any of the methods set out previously to be performed.

According to an aspect there is provided a computer program comprising computer executable code which when cause any of the methods set out previously to be performed.

According to an aspect, there is provided a computer readable medium comprising program instructions stored thereon for performing at least one of the above methods.

According to an aspect, there is provided a non-transitory computer readable medium comprising program instructions which when executed by the apparatus, cause the apparatus to perform any of the methods set out previously.

According to an aspect, there is provided a non-transitory computer readable medium comprising program instructions which when executed cause any of the methods set out previously to be performed.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

### DESCRIPTION OF FIGURES

Embodiments will now be described, by way of example only, with reference to the accompanying Figures in which:

FIG. 1 shows a signal flow for intra-DU (distributed) inter-cell beam management operation;

FIG. 2 shows a signal flow for L1/2 centric mobility;

FIG. 3 shows a UE being served by a source-DU with ICBM (inter-cell beam management) area with a target-DU for handover;

FIG. 4 shows a signal flow where a target-DU is responsible for a final LLM (lower layer mobility) decision;

FIG. 5 shows another signal flow where a target-DU is responsible for a final LLM decision;

FIG. 6 shows a signal flow where a source-DU is responsible for a final LLM decision;

FIG. 7 shows a signal flow where a control unit is responsible for a final LLM decision;

FIG. 8 shows a schematic diagram of an example architecture in which some embodiments may be provided;

FIG. 9 shows a schematic diagram of an example communications device;

FIG. 10 shows a schematic diagram of an example apparatus;

FIGS. 11A and 11B depict RAN (radio access network) architectures;

FIG. 12 shows a schematic representation of a non-volatile memory medium storing instructions which when executed by a processor allow a processor to perform one or more of the steps of any of the methods of FIGS. 13 to 16;

FIG. 13 shows a first method of some embodiments;

FIG. 14 shows a second method of some embodiments;

FIG. 15 shows a third method of some embodiments; and

FIG. 16 shows a fourth method of some embodiments.

### DETAILED DESCRIPTION

In the following certain embodiments are explained with reference to mobile communications devices capable of communication via a wireless cellular system and mobile communication systems serving such mobile communications devices. Before explaining in detail, the exemplifying embodiments, certain general principles of a wireless communication system, access systems thereof, and mobile communications devices are briefly explained with reference to FIGS. 8, 9 and 10 to assist in understanding the technology underlying the described examples.

In particular, in the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. The embodiments may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

A basic system architecture of a (tele)communication network including a mobile communication system where some examples of embodiments are applicable may include an architecture of one or more communication networks including wireless access network subsystem(s) and core network(s). Such an architecture may include one or more communication network control elements or functions, access network elements, radio access network elements, access service network gateways or base transceiver stations, such as a base station (BS), an access point (AP), a NodeB (NB), an eNB or a gNB, a distributed unit (DU) or a centralized/central unit (CU), which controls a respective coverage area or cell(s) and with which one or more communication stations.

In a wireless communication system 100, such as that shown in FIG. 8, mobile communications devices, user devices, user equipment (UE) 102, 104, 105 are provided wireless access via at least one base station (e.g., next generation NB, gNB), similar wireless transmitting and/or receiving node or network node. Base stations may be controlled or assisted by at least one appropriate controller apparatus, so as to enable operation thereof and management of mobile communications devices in communication with the base stations. The controller apparatus may be located in a radio access network (RAN) (e.g., wireless communication system 100) or in a core network (CN) (not shown) and may be implemented as one central apparatus or its functionality may be distributed over several apparatuses.

In FIG. 8, base stations 106 and 107 are shown as connected to a wider communications network 113 via gateway 112. A further gateway function may be provided to connect to another network.

The communication area (or coverage area) of the base stations may be referred to as a “cell.” The base stations and the UEs may be configured to communicate over the transmission medium using any of various radio access technologies (RATs), also referred to as wireless communication technologies, or telecommunication standards.

As illustrated in FIG. 8, while one of the base stations may act as a “serving cell” for UEs, a UE may also be capable of receiving signals from (and possibly within communication range of) one or more other cells (which might be provided by the base stations and/or any other base stations), referred to as “neighbouring cells”.

As mentioned above, a base station may include multiple network nodes such as a superordinated controller node implementing higher network layers such as layer 3/RRC (radio resource control) and one or more subordinated nodes such as distributed units (DUs) typically implementing lower network layers such as the physical layer (layer 1, L1) and layer 2(L2 ). Note that these units may be geographically co-located or geographically dislocated to a certain extent.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example, Wireless Local Area Network (WLAN) and may be WLAN Access Points (APs).

The communications devices 102, 104, 105 may access the communication system based on various access techniques, such as Code Division Multiple Access (CDMA), or Wideband CDMA (WCDMA). Other non-limiting examples comprise Time Division Multiple Access (TDMA), Frequency Division Multiple Access (FDMA) and various schemes thereof such as the Interleaved Frequency Division Multiple Access (IFDMA), Single Carrier Frequency Division Multiple Access (SC-FDMA) and Orthogonal Frequency Division Multiple Access (OFDMA), Space Division Multiple Access (SDMA) and so on.

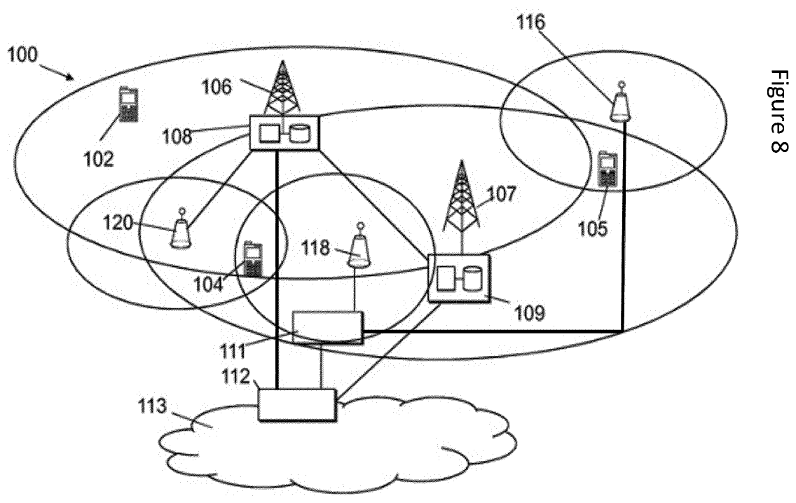

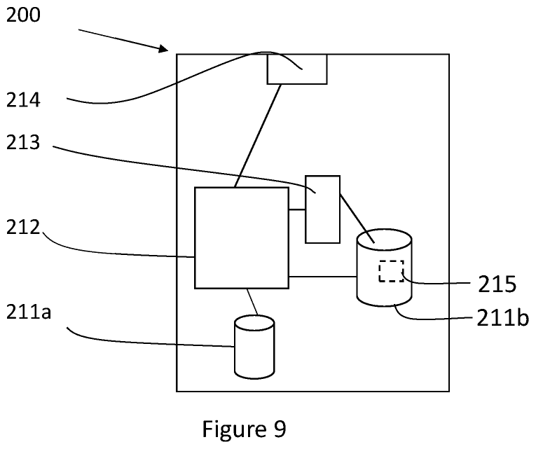

FIG. 9 illustrates an example of an apparatus 200. The apparatus may be provided in radio access node. The apparatus may be provided in source node, a target node and/or a central unit. The apparatus may be provided in a distributed unit. The apparatus may have at least one processor and at least one memory storing instructions that, when executed by the at least one processor cause one or more functions to be performed. In this example, the apparatus may comprise at least one random access memory (RAM) 211a, and/or at least one read only memory (ROM) 211b, and/or at least one processor 212, 213 and/or an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects.

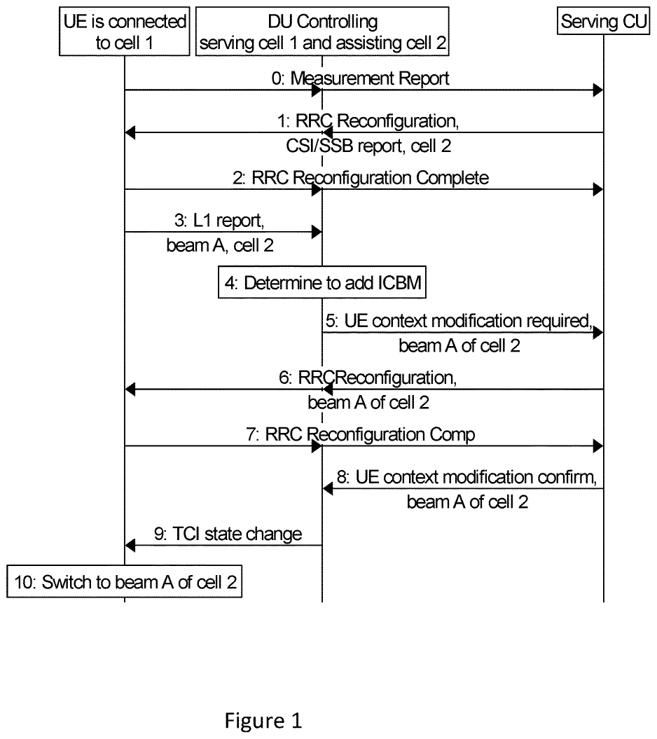

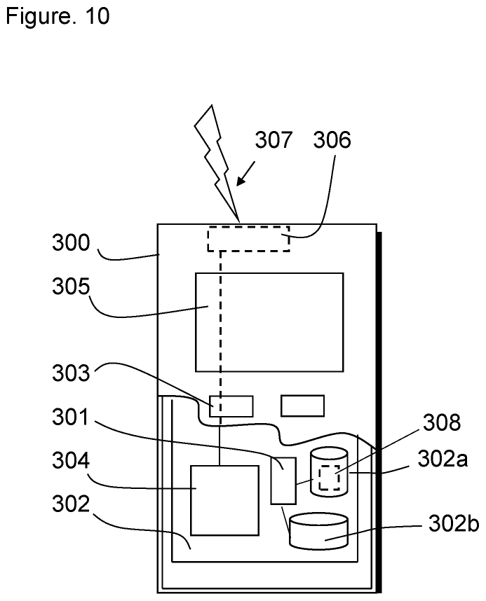

FIG. 10 illustrates an example of a communications device 300, such as the UE illustrated on FIG. 1. The communications device 300 may be provided by any device capable of sending and receiving radio signals. The communications device 300 may provide, for example, communication of data for carrying communications. The communications may be one or more of voice, electronic mail (email), text message, multimedia, data, machine data and so on.

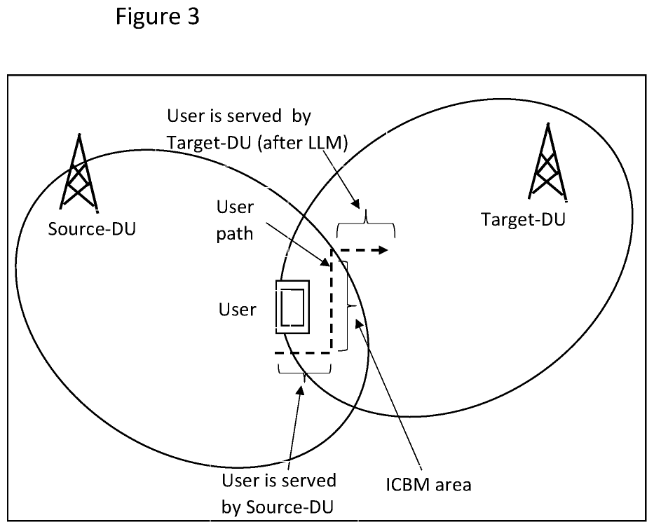

The communications device 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the communications device.

The communications device 300 may be provided with at least one processor 301, and/or at least one memory ROM 302a, and/or at least one RAM 302b and/or other possible components 303 for use in software and hardware aided execution of tasks it is designed to perform, including control of access to and communications with access systems and other communications devices. The at least one processor 301 is coupled to the RAM 302b and the ROM 302a. The at least one processor 301 may be configured to execute an appropriate software code 308. The software code 308 may for example allow the performance of one or more of the present aspects. The software code 308 may be stored in the ROM 302a.

The processor, storage and other relevant control apparatus can be provided on an appropriate circuit board and/or in chipsets. This feature is denoted by reference 304.

The communications device may optionally have a user interface such as keypad 305, touch sensitive screen or pad, combinations thereof or the like. Optionally one or more of a display, a speaker and a microphone may be provided depending on the type of the communications device.

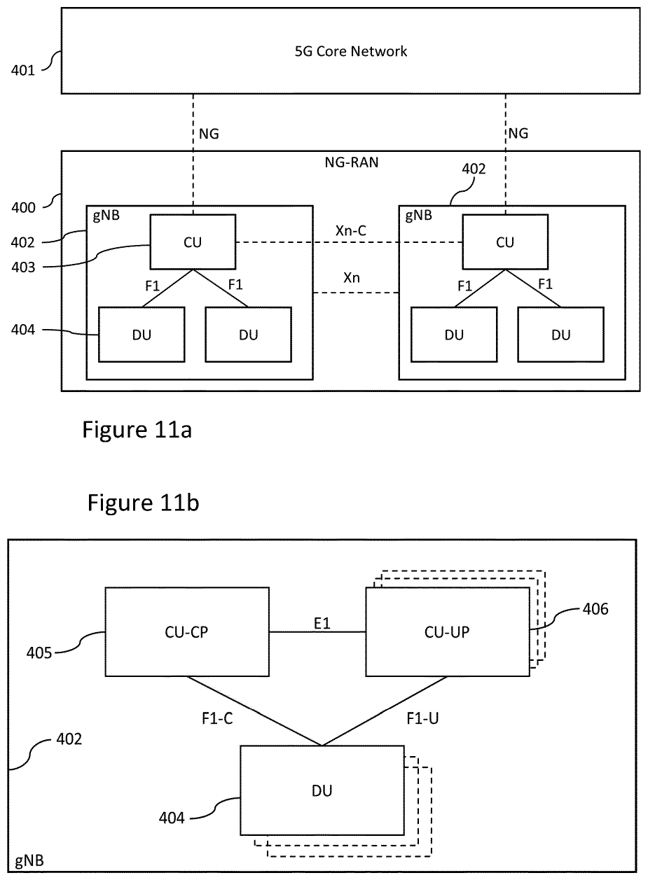

FIGS. 11A and 11B depict examples of radio access network (NG-RAN) architectures 400 with gNBs 402. In FIG. 11A, a gNB 402 employs NR user/control plane protocols to serve UEs and is connected to the 5GC (5G core) 401 via the logical NG interface and to other gNBs 402 through Xn interface to support the exchange of signalling information and forwarding PDUs (packet data units). The gNB 402 of FIG. 11A comprises a central unit (i.e., CU) 403 and one or more distributed units (i.e., DU) 404. The CU is a logical node hosting RRC, SDAP (service data adaption protocol) and PDCP (packet data convergence protocols) protocols of the gNB or RRC and PDCP protocols of the gNB that controls the operation of one or more DUs 404. The CU 403 terminates the F1 interface connected with the DUs 404 subordinate to the CU 403. The DU 404 is a logical node hosting RLC (radio link control), MAC (medium access control) and PHY (physical) layers of the gNB 402, and its operation is partly controlled by CU 403. One DU 404 supports one or multiple cells. One cell is supported by one DU 404. The DU 404 terminates the F1 interface connected with the CU 403.

One DU 404 is connected to one CU 403 via F1 interface. NG, Xn, and F1 are logical interfaces. The Xn-C interface interconnects CUs 403 of different gNBs 402. The gNB 402 can also comprise a CU control-plane (CU-CP), multiple CU user-plane (CU-UPs), and multiple DUs, which are depicted in more detail in FIG. 11B.

FIG. 11B illustrates the architecture with separation of the control plane and the user plane for the gNB-CU (i.e., CU-CP and CU-UP) 403. The CU-CP 405 is a logical node hosting the RRC and the control plane part of the PDCP protocol of the CU 403 for a gNB 402. The CU-CP 405 terminates the E1 interface connected with the CU-UP 406 and the F 1-C interface connected with the DU 404. The CU-UP 406 is a logical node hosting the user plane part of the PDCP protocol of the CU 403 for a gNB, and the user plane part of the PDCP protocol and the SDAP protocol of the CU 403 for a gNB 402. The CU-UP 406 terminates the E1 interface connected with the CU-CP 405 and the F1-U interface connected with the DU 404. The CU-UP 406 may be connected to one CU-CP 405, to multiple CU-UPs 406 and multiple DUs 404 under the control of the same CU-CP 405.

Different functional splits between the central and distributed unit are possible, e.g.:
Option 1 (1A-like split): The function split in this option is similar to a 1A architecture in DC (dual connectivity). RRC is in the central unit (CU). PDCP, RLC, MAC, physical layer and RF (radio frequency) are in the distributed unit (DU).
Option 2 (3C-like split): The function split in this option is similar to the 3C architecture in DC. RRC and PDCP are in the central unit. RLC, MAC, physical layer and RF are in the distributed unit.
Option 3 (intra RLC split): Low RLC (partial function of RLC), MAC, physical layer and RF are in the distributed unit. PDCP and high RLC (the other partial function of RLC) are in the central unit.
Option 4 (RLC-MAC split): MAC, physical layer and RF are in the distributed unit. PDCP and RLC are in the central unit.

Other functional splits may alternatively be used.

It should be appreciated that other embodiments may be used with any other suitable architecture have distributed and central units.

Inter-cell beam management (ICBM) has been proposed. As beam level mobility, the serving of the UE from different beams is defined. Beam level mobility does not require explicit RRC signalling to be triggered. Beam level mobility can be within a cell, or between cells, where the latter refers to inter-cell beam management (ICBM). In this type of mobility, the serving cell of the UE does not change. For ICBM, a UE may receive or transmit UE dedicated channels/signals (monitored on UE specific search space) via a transmission reception point (TRP) associated with a physical cell ID (PCI) different from the PCI of a serving cell, while non-UE-dedicated (monitored on common search space) channels/signals can only be received via a TRP associated with a PCI of the serving cell. In other words, a UE can use a beam of a different cell to that of its source-DU.

The gNB provides, in advance, via RRC signalling to the UE the measurement configuration containing configurations of SSB/CSI (synchronization signal block/channel status information) resources and resource sets, reports and trigger states for triggering channel and interference measurements and reports.

In case of ICBM, a measurement configuration includes SSB resources associated with PCIs different from the PCI of a serving cell. Beam level mobility (i.e., switching between beams) is then dealt with at lower layers by means of physical layer and MAC layer control signalling, and RRC is not required for triggering of beam change, or for knowing which beam is being used at a given point in time.

FIG. 1 schematically illustrates an example of a signalling/messaging flowchart for an intra-DU ICBM procedure. In intra-DU ICBM scenarios, both the source and target cells (referred to as cell 1 and cell 2 respectively in FIG. 1) are under the control of the same serving (source) DU. It is also generally assumed that, in the example of FIG. 1, before the method start, the UE is connected to cell 1 (i.e., the source/serving) and does not have an active inter-cell beam management configuration enabled.

In step 0, the UE sends a measurement to the serving CU. The UE is connected to cell 1 and does not have inter-cell beam management active. At this stage, the UE performs L3 measurement of neighbouring cells and reports them to the serving CU (via cell 1).

In step 1, the CU configures the UE with LI measurements for a beam A of the neighbour cell 2 (i.e., the target set) for example through an RRC reconfiguration message (or by using any other suitable message). This may be based on the L3 measurements in step 0. It is to be noted that, although a single beam A is used as a reference in the example embodiment of FIG. 1, the skilled person would understand and appreciate that, in some other possible implementations, more than one beam may be configured for measurement. In addition, as can also be understood and appreciated by the skilled person, the CU may also configure the UE with a suitable measurement gap, in case the target-DU might operate in another bandwidth part (BWP) than the current BWP of the UE (that is in communication with the serving DU). The CU may configure the UE via the DU.

The UE may respond to such configuration for example by sending a corresponding RRC reconfiguration complete message (or the like) to the serving CU, as exemplarily shown in step 2, This may be via the DU.

In step 3, the UE reports L1 measurements (e.g., reference signal received power (RSRP) or the like) for beam A of cell 2 to the DU.

In step 4, the DU may observe the quality of beam A of cell 2 and determine that the UE may benefit from radio resources of cell 2. The serving-DU may decide to initiate the ICBM procedure and includes beam A of cell 2 (the borrowed beam) for the beam management operation of the UE.

In step 5, the serving-DU may indicate a beam A of cell 2 to be included in the beam management operation of the UE, e.g., by sending a UE context modification request message (or similar) to the CU.

In response thereto, the CU may configure the UE with the beam management information provided by the source-DU, for example by transmitting another RRC reconfiguration message (or the like) as shown in step 6.

Upon receipt of a corresponding RRC reconfiguration complete message (or the like) from the UE (step 7), the CU may in turn indicate or acknowledge the successful completion of the UE configuration to the source-DU in step 8. For example, the CU may transmit a corresponding UE context modification confirmation/completion message (or the like) in step 8.

The DU may then, in step 9, send a TCI (transmission configuration indicator) state change message (e.g., as part of a MAC control element (CE) or in any other suitable form) to activate the beam A of cell 2 for the UE.

The UE may, upon receipt of such TCI state information, initiate the ICBM procedure with the addition of beam A of cell 2 in the beam management.

The inter-cell beam management procedure may be understood as not being aimed to provide mobility-related functionality (e.g., switching, handover, etc.) to different cells but is rather used to provide an enhanced radio coverage to the UE as a temporary solution in order to avoid L1-2 centric mobility. In other words, a beam from a neighbouring cell under the control of same CU as the current cell may be “borrowed” or used.

Lower layer mobility (LLM), referred to also as L1/2 inter-cell mobility, is an objective for mobility enhancement. For example, this may be looked at the context of Rel. 18 of the 5G standards. According to the paradigm description, the decision about the cell change is based on L1 measurements and is made in the MAC layer in the distributed unit (DU).

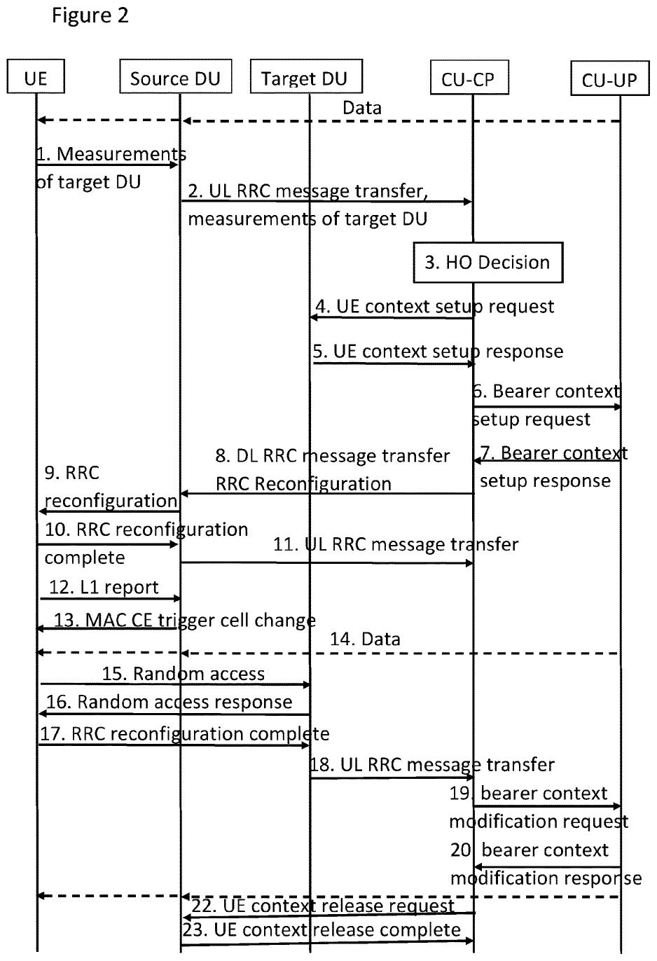

FIG. 2 shows a message exchange for an inter-DU LLM scenario.

In this example, the UE provides the L3 measurements to the source-DU (step 1), which are forwarded to the CU-CP (step 2). Based on these measurements the CU-CP decides about the cell preparation (HO (handover) decision-step 3) and proceeds in the setting up of the UE context in the target-DU (steps 4-5).

Then CU-CP communicates with CU-UP to perform the bearer context setup (steps 6-7).

In step 8, the CU-CP forwards the RRC Reconfiguration message to the source-DU using a DL (downlink) RRC message transfer and the latter forwards it to the UE (step 9). The UE responds with an RRC reconfiguration complete message (step 10) which is then forwarded to the CU-CP (step 11).

The UE based on its configuration provides periodic L1 reports to the source-DU (step 12).

Once the source-DU decides that the UE should be handed over to another DU (i.e., a target-DU), the source-DU triggers the cell switch, using a MAC CE (step 13). Up to this point the UE receives data from the serving or source-DU.

Then the UE applies the RRC configuration for the target cell of the target-DU-indicated by the MAC CE and performs a random access (RA) procedure (step 15) and receives a random access response from the target-DU (step 16).

After the RA procedure, the UE transmits an RRC reconfiguration complete to the target cell of target-DU (step 17), which is forwarded to the CU-CP (step 18).

The CU-CP performs bearer modification (steps 19-20) with the CU-UP, to update the bearer setup and for the latter to start forwarding the data to the target-DU (and stop forwarding data to the source-DU).

Once this is completed the UE starts receiving data from the target-DU (step 21).

Finally, the CU-CP releases the UE context from the source-DU with a UE Context Release Request (steps 22-23).

Some embodiments may address LLM and ICBM co-existence for an inter-DU scenario. Some embodiments may provide methods for performing LLM when the UE is served through ICBM.

FIG. 3 shows an example scenario of LLM and ICBM co-existence for inter-DU scenario in which a mobile user is moving from a source-DU toward a target-DU.

At some point, the network may decide to initiate ICBM for the UE. This could be due to the fact that the UE still can receive and decode the source-DU's common search space (e.g., for connected mode paging/short message reception/system information reception) but reports higher signal quality from the target-DU compared to that of the source-DU (e.g., RSRP target>RSRP source). The network, considering the L1/3 measurements, has on the other hand decided that the UE should not be handed over to the target cell yet (based on for example, measurement variations, mobility prediction algorithms indicating that there is a high probability of “too early HO”, to avoid ping-pong probability due to small coverage islands (especially in FR2 beamformed systems), to avoid HO interruption at the moment because of ongoing service requirements and/or based on any other suitable criteria).

Load balancing and/or interference management can be triggers for ICBM where the source-DU is congested with a high number of users to serve and thus the network may decide to offload part of traffic to neighbour cells (e.g., a target-DU).

As the UE proceeds further toward the target-DU, the network may decide to perform HO using a LLM procedure, where the UE applies the target-DU RRC-configuration and disconnects from the source-DU once dictated to do so from the serving DU.

In the example shown in FIG. 3, the UE is being served by a beam from the target cell/DU which is also responsible for beam management.

Following a straightforward application of the LLM and ICBM paradigms, the target cell/DU would direct the UE to be served by the serving cell/DU, i.e., terminating of the borrowed beam of target cell and ICBM. This returns control of the UE into the serving DU/cell which then determines bad radio conditions. This may be based on UE measurements. The serving-DU then directs the UE to the target-DU using the LLM procedure of FIG. 2. This may introduce delay. This may even cause the LLM HO to fail for example as the UE moves out of the coverage of serving cell/DU.

Some embodiments may enable the coexistence of ICBM and LLM.

In some embodiments, LLM may be configured while ICBM is initiated.

Some embodiments will be described which show information which is exchanged between the parts of the RAN node-that is the source-DU, the CU-CP and the target-DU to be able to initiate and prepare the inter-DU LLM while ICBM is in progress.

It should be appreciated that in some embodiments, one of the nodes may be responsible for making the final LLM decisions.

In some embodiments, the source-DU may make the decision.

In some embodiments, the target-DU may make the decision.

In some embodiments, the CU-CP may make the decision.

In some embodiments, the CU-CP will need to know when DUs support the coexistence of ICBM and LLM.

In some embodiments, a DU will provide information to the CU-CP as to whether the coexistence of ICBM and LLM is supported by that DU. For example, this information may be provided by way of an IE (information element) or in any other suitable way. This IE may indicate the support of the coexistence of ICBM and serving cell change. This IE may indicate that the DU is capable to switch from ICBM operation to serving cell operation without disconnecting ICBM.

The CU-CP will use the information provided by the DU so that the procedure is only triggered if the co-existence feature is supported.

In some embodiments, it may be assumed that a DU will support the co-existence feature so no IEs or the like are required.

In some embodiments, the UE will provide information to the CU-CP as to whether the coexistence of ICBM and LLM is supported. For example, this information may be provided by way of an IE (information element) or in any other suitable manner. This IE may be a UE capability indicator. This IE may indicate support of coexistence of ICBM and serving cell change. This IE may indicate that the UE is capable to switch from ICBM operation to serving cell change operation without disconnecting ICBM.

The CU-CP will use the information provided by the UE so that the procedure is only triggered if the co-existence feature is supported.

In some embodiments, it may be assumed that a UE will support the co-existence feature so no IEs or the like are required.

In some embodiments, the target-DU may be responsible for making the LLM decision.

The CU may provide the UE with measurement configurations and reporting.

In conjunction with both source-DU and target-DU, the CU may gather and share required LLM and ICBM configurations/parameters between the source-DU, the target-DU, and the UE.

The CU optionally, may indicate the LLM trigger condition to the target-DU.

After the execution of the ICBM, the UE may be configured to measure and report a L1 measurement to the target-DU. This may be through a beam of a non-serving cell of the target-DU.

Based on the received measurement, the target-DU may decide to trigger LLM. If the measurements, e.g., of the non-serving cell, meet the criteria, the target-DU may initiate the cell change by sending a MAC-CE command to the UE.

The UE may then switch cell by starting to apply LLM-specific configuration and monitor the common search space of the target-DU.

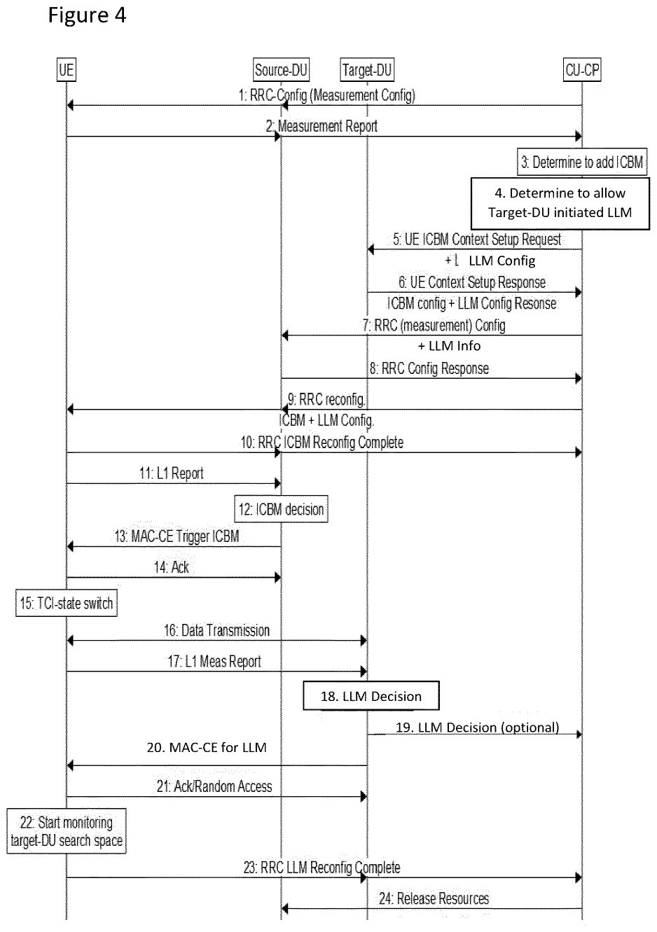

Reference is made to FIG. 4 which shows a signal flow of some embodiments. In this example signal flow, the target-DU is responsible for making a final LLM decision

In step 1, the UE is connected to the source-DU. The CU-CP configures the UE with the required L3 measurements. This measurement configuration may be provided to the UE by the CU-CP via the source-DU. The measurement configuration may be provided in a RRC configuration message. Alternatively, or additionally, the required measurements may be L1 measurement. However, L1 measurements are not forwarded to the CU-CP in step 2. The source-DU will store L1 measurement.

In step 2, after performing the measurements, the UE sends the L1 and/or L3 measurement report to the source-DU. The source-DU forwards the L3 measurement report to CU-CP.

In step 3, the CU-CP determines that ICBM is to be added to better serve the UE. This determination is based on the measurement reports. The determination may take into account one or more other factors such as the traffic load and UL/DL interference at the source and/or target-DUs.

In some embodiments, the CU-CP determines that ICBM is to be added for the UE based alternatively or additionally on a request from the source-DU. For example, this may be based on a determination made by the source-DU using the L1 measurement reports that ICBM is to be used.

In step 4, the CU-CP may decide to enable target-DU initiated LLM. The CU-CP may assign the decision to trigger lower-layer mobility to the target-DU.

In step 5, the CU-CP sends a request to the target-DU and indicates that this is for ICBM. The request may be a UE context setup request in some embodiments.

In some embodiments, the CU-CP informs the target-DU about the responsibility for making LLM decision.

The CU-CP may provide the corresponding parameters (configuration) that are necessary for initiating LLM. For example, the parameter configuration can comprise information about the CSI resources and/or TCI state configuration of the serving cell in the source-DU and/or parameters that control the LLM decision. The parameters that control the LLM decision may comprise for example an offset and/or threshold for comparing serving cell and non-serving cell measurements.

In step 6, the target-DU sends a response to the CU-CP. This may be a UE context setup response in some embodiments.

The response may provide the LLM target cell configuration (of the cell served by the target-DU) to the CU-CP which needs to be applied by the UE when LLM is triggered.

The target-DU sends the confirmation and target-DU related configuration for ICBM. The target-DU may provide the LLM target cell configuration (of the cell served by the target DU) to the CU-CP which needs to be applied by the UE when LLM is triggered. The target-DU may provide the UE required L1 measurement configuration that needs to be applied by the UE when switching to the non-serving cell of target DU.

In step 7, the CU-CP sends the ICBM configuration and/or context updates acquired from the target-DU to the source-DU.

The CU-CP may inform the source-DU about the responsibility of the target-DU for making a LLM decision after execution of the ICBM. Alternatively, or additionally, at least a part of the information provided in step 7 to the source-DU may be provided later in step 9.

The CU-CP may send a RRC measurement configuration message to the source-DU with the ICBM and/or LLM information.

In step 8, the source-DU confirms that it has received the information sent in step 7 by sending a response to the CU-CP. This response may be in a configuration response message. This response may be a RRC configuration response.

In step 9, the CU-CP transmits a reconfiguration message to the UE. The reconfiguration message may be a RRC reconfiguration message. This may be via the source-DU. The reconfiguration message may include measurement configuration, ICBM configuration, and/or LLM configuration. The LLM configuration may be the LLM target cell configuration.

In step 10, the user equipment may apply the measurement and pre-ICBM related configurations. The UE may store ICBM/LLM configurations which are to be applied when performing an ICBM/LLM cell change. The UE may send a reconfiguration complete message to the CU-CP. This may be via the source-DU. This may be a RRC reconfiguration complete message.

In step 11, based on the received measurement configurations, the UE performs and reports measurements to the source-DU. This may be L1 measurements.

In step 12, the source-DU may decide to trigger ICBM. This done in step 13 by sending a command to the UE. This command indicates to the UE that it should monitor and receive data from the specified target-DU beam while monitoring the source-DU's common search space. The command may be a TCI-state switch command. This TCI-state switch command may be sent through the DCI or MAC-CE.

In step 14, the UE sends an acknowledgement to the source-DU.

In step 15, the UE performs a switch. In other words, the UE uses one or more beams of the target-DU. This may be a TCI-state switch.

In step 16, the UE communicates the data (for example using PDSCH (physical downlink shared channel, PUSCH (physical uplink shared channel, PDCCH (physical downlink control channel), and/or PUCCH physical uplink control channel) via the target-DU specified beam.

In step 17, the UE measures and reports the beam measurement to the target-DU. This may be a L1 measurement. The measurement will be of one or more beams of the target-DU. The measurement may be of one or more beams of the source-DU.

In step 18, based on the received measurement values the target-DU may decide to perform LLM. The measurement values may be source-DU measurement values, target-DU measurement values and/or measurement values of one or more other neighbouring cells. This may happen for example when UE reports higher a RSRP/RSRQ (reference signal received power/reference signal received quality) from the target-DU as compared to the source-DU.

In step 19, the target-DU may optionally inform CU-CP of the LLM decision. This may allow for faster and/or improved resource management at the CU-CP by releasing more quickly the reserved resources of other cells. The indication may serve as a trigger to provide further cell specific/full beam management configuration (e.g., full TCI (transmission configuration indicator) state list). This step is optional in some embodiments.

In step 20, the target-DU triggers LLM. The target-DU may trigger the LLM by sending the MAC-CE for LLM to the UE.

In step 21, the UE then confirms the received command and potentially performs a random-access. As there is already a link between the user equipment and target-DU, the procedure can be handled without using the RACH (random access channel).

In step 22, the UE then starts to monitor the search space of the target-DU. This may be a common search space and/or the UE specific search space. The UE applies the LLM configuration and in step 23, sends a complete command to the CU-CP indicating that LLM reconfiguration has been completed. This may be a RRC complete command.

In step 24, the CU-CP informs the source-DU that the source-DU is to release the resources allocated to the UE.

Some embodiments may transmit both the LLM and ICBM configurations to the UE in one signal transmission. This may be advantageous.

Some embodiments may require no additional signalling and have no delay in preparing and triggering LLM procedure. This may be advantageous.

In some embodiments, since the target-DU is responsible for making final LLM decision, there is no need to forward the L1-measurement report (see step 17) either to CU-CP or to the source-DU. This may be advantageous.

In some embodiments, the target-DU controlling a non-serving cell in ICBM is to receive L1 beam measurements from the UE for the sake of triggering lower layer mobility for the UE, if needed.

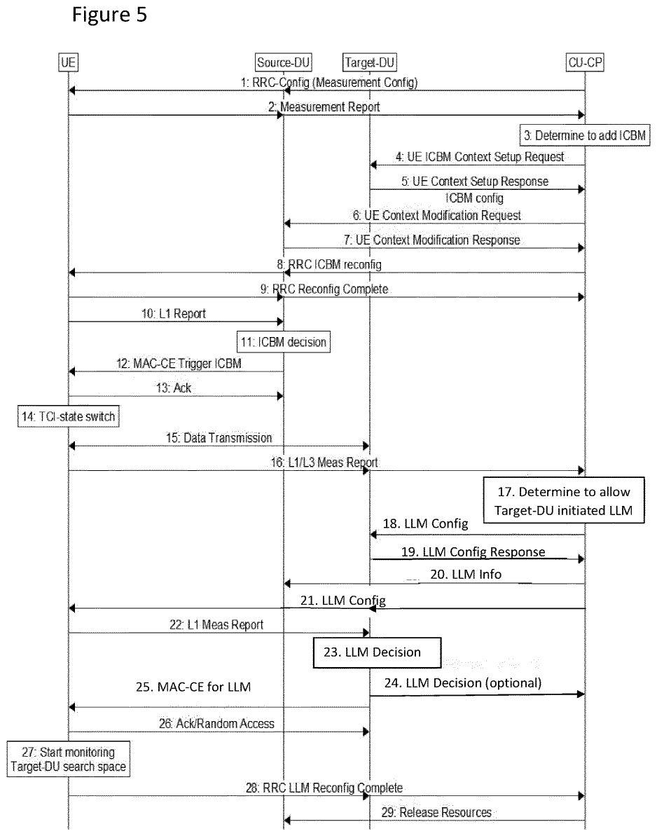

Reference is made to FIG. 5 which shows another signal flow of some embodiments where the target-DU is responsible for making the LLM decision. In this example signal flow, instead of configuring the UE with both ICBM and LLM configurations as discussed in relation to FIG. 4, the CU-CP may decide to configure LLM decision making to the target-DU after establishing ICBM and receiving a further measurement report.

In FIG. 5, steps 1 to 3 correspond to those of FIG. 4. However, step 4 of FIG. 4 is omitted.

In step 4, the CU-CP sends a UE request to the target-DU and indicates that this is for ICBM. This may be a UE context setup request.

In step 5, the target-DU sends UE response to the CU-CP with related target-DU related configuration for ICBM. This may be a UE context setup response.

In step 6, the CU-CP sends a modification request to the source-DU. This may be a UE context modification request.

In step 7, the source-DU sends a UE response to the CU-CP. This may be a UE context modification response.

In step 8, the CU-CP transmits reconfiguration message to the UE. This may be a RRC reconfiguration message. This may be via the source-DU. The reconfiguration message may include measurement configuration and/or ICBM configuration.

In step 9, the user equipment may apply the measurement and pre-ICBM related configurations. The UE may store ICBM configurations which are to be applied when performing an ICBM cell change. The UE may send an RRC reconfiguration complete message to the CU-CP. This may be a RRC reconfiguration complete message This may be via the source-DU.

Steps 10 to 15 correspond to steps 11 to 15 of FIG. 4.

In step 16, the UE send a L1 and/or L3 measurement report to the CU-CP. This may be via the target-DU.

In step 17, the CU-CP determines that target-DU initiated LLM is to be allowed.

In step 18, the CU-CP is configured to send the LLM configuration to the target-DU.

In step 19, the target-DU is configured to send a LLM configuration response to the CU-CP.

In step 20, the CU-CP is configured to send the LLM information to the source-DU.

In step 21, the CU-CP is configured to send the LLM configuration to the UE via the target-DU.

Steps 22 to 29 correspond to steps 17 to 24 of FIG. 4.

In some embodiments, the source-DU is responsible for making LLM decision.

In this case, the CU may provide the UE with measurement configurations and reporting.

In coordination with both source-DU and target-DU, the CU may then gather, and share the required LLM and ICBM configurations and/or parameters between the source-DU, target-DU, and UE.

After the execution of the ICBM, the UE may be configured to measure and report L1 measurements to the target-DU through a borrowed beam.

The Target-DU may then forward the measurement to the source-DU either through the inter-DU interface or via the CU-CP.

Based on the received measurements, the source-DU may decide to perform LLM, and send the LLM decision to the target-DU. This may be directly or via the CU-CP.

The target-DU may then send the LLM execution message to the UE. This may be as part of the MAC-CE.

The UE may then switch the cell by starting to apply LLM-specific configuration and monitor the common search space of the target-DU.

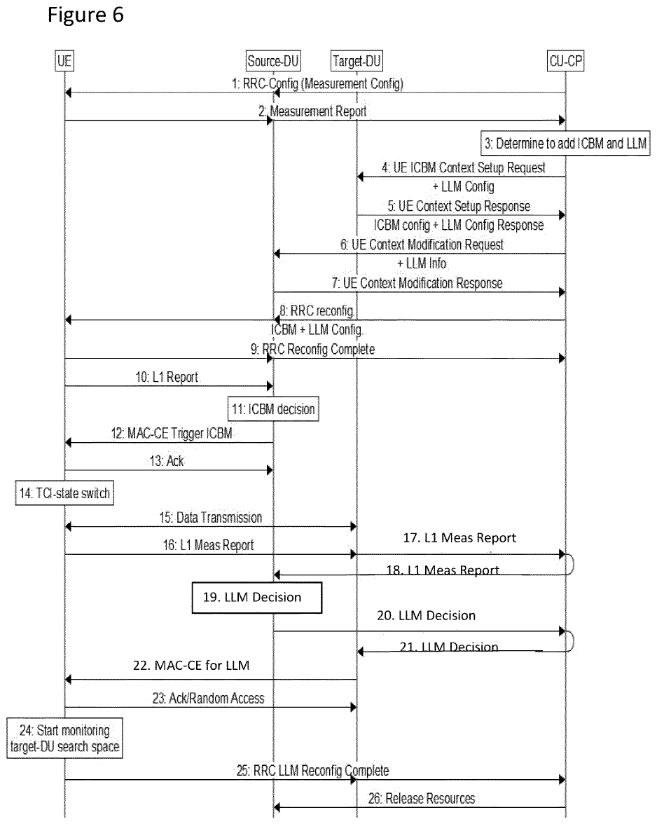

Reference is made to FIG. 6 which shows a signalling flow example where the source-DU is responsible for making a LLM decision.

Compared to the signal flow shown in FIG. 4, the CU-CP configures the target-DU to forward the L1 beam measurement to the source-DU (step 4).

In FIG. 6, steps 1 and 2 correspond to those of FIG. 4.

In step 3, the CU-CP determines that ICBM and LLM is to be added to better serve the UE. This determination is based on the measurement reports. The determination may take into account one or more other factors such as the traffic load and UL/DL (uplink/downlink) interference at the source and/or target-DUs.

Steps 4 and 5 correspond to steps 5 and 6 of FIG. 4.

In step 6, the CU-CP sends a modification request to the source-DU with LLM information. This may be a UE context modification request. The source-DU is thus configured to forward the LLM command to the target-DU after the ICBM operation is initiated.

In step 7, the source-DU sends a modification response to CU-CP. This may be a UE context modification response.

Steps 8 to 16 correspond to steps 9 to 17 of FIG. 4.

In step 17, the L1 measurement report is sent from the target-DU to the CU-CP.

In step 18, the L1 measurement report is sent from the CU-CP to the source-DU.

In step 19, based on the received measurement values the source-DU may decide to perform LLM. This may be using a similar criterion to that outlined in relation to FIG. 4.

In step 20, the source-DU may inform CU-CP of the LLM decision.

In step 21, the CU-CP may inform the target-DU of the LLM decision.

Steps 22 to 26 correspond to steps 20 to 24 of FIG. 4.

When there is a direct connection, between the source-DU and the target-DU, the L1 measurement report may be sent directly from the target-DU to the source-DU. (This would replace steps 17 and 18 of FIG. 6).

When there is a direct connection, between the source-DU and the target-DU, the LLM command may be sent directly to the target-DU from the source-DU. This would replace steps 20 and 21 of FIG. 6).

The source-DU may be enabled to receive from the target-DU L1 beam measurements when the UE is served by a non-serving cell in ICBM. Based on the received measurements, the source-DU is able to trigger LLM.

In one modification to the signal flow shown in FIG. 6, the CU-CP can provide the LLM permission to the Source-DU after receiving measurement report in Step 17. In this modification, the LLM is only set up when the CU-CP receives the measurement report and determines that the source-DU initiated LLM is to be allowed.

In some embodiments, the CU-CP may be responsible for making the LLM decision.

The CU-CP may provide the UE with both ICBM and LLM configuration.

The CU-CP may provide the required ICBM configuration to the source-DU and the target-DU.

After the execution of the ICBM, the UE is configured to measure and report L1 measurements to the target-DU through the borrowed beam.

The target-DU then forwards the measurement to the CU-CP.

Based on the received measurements, the CU-CP can decide to perform LLM, and send the LLM decision to the target-DU.

The target-DU then transmits the LLM execution message to the UE. This may be with a MAC-CE.

The UE then switches the cell by starting to apply LLM-specific configuration and monitoring the common search space of the target-DU.

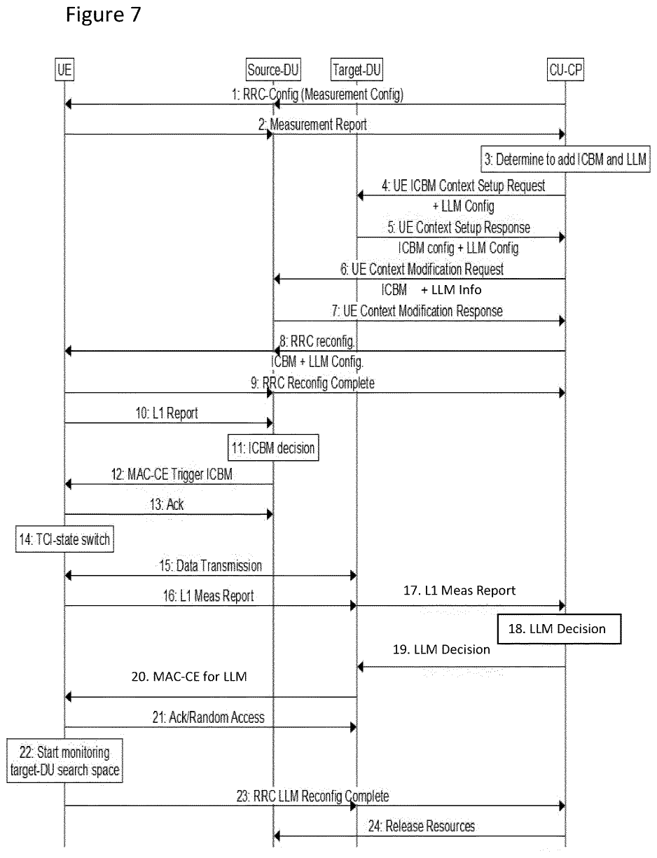

Reference is made to FIG. 7 which shows a signal flow example where the CU-CP makes the LLM decision.

Steps 1 to 17 of FIG. 7 correspond to steps 1 to 17 of FIG. 6. In this flow, the target-DU is configured to forward the L1-measurement reports to the CU-CP in step 17. In step 17, the amount of L1-RSRP reporting towards CU may be limited by the target-DU. For example, if the new report would contain same or similar information as the previous information, the report would not be forwarded or if the top N beams in the L1-RSRP report are the same, the report would not be forwarded. Alternatively, or additionally, the forwarded L1-RSRP report may comprise averaged/filtered L1-RSRP reports/measurements. The reporting may be triggered when the difference between at least one target-DU beam is reported X dB higher than the highest source-DU beam.

In step 18, the CU-CP makes the LLM decision. The CU-CP decides on performing LLM based on the received reports.

In step 19, the CU-CP send the LLM decision to the target-DU.

Steps 20 to 24 correspond to steps 22 to 26 of FIG. 6.

It should be noted, that in step 6, the source-DU may be configured to disable the LLM triggering to the target-DU after the ICBM operation is initiated.

It should be noted, that after step 12, the triggering of the ICBM operation is indicated to the CU-CP. This can be done with the forwarding of L1-RSRP to the CU-CP. The CU-CP uses the indication to determine if it can initiate the LLM procedure towards the UE.

The CU-CP may be enabled to receive L1 beam measurements from the non-serving cell in ICBM for the sake of deciding on LLM.

Some embodiments may allow the triggering of LLM when the UE is served by a non-serving cell in ICBM which improves mobility robustness given that the configuration and preparation of LLM may be provided beforehand.

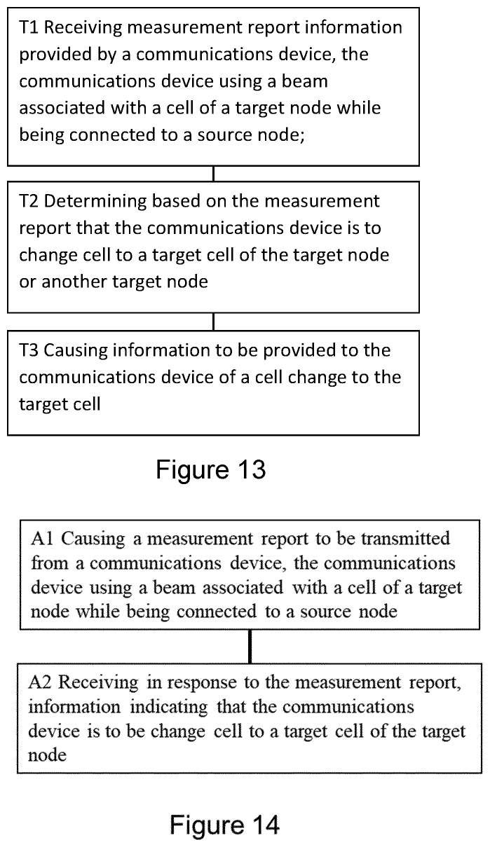

Reference is made to FIG. 13 which shows a first method of some embodiments.

This method may be performed by an apparatus. The apparatus may be provided in a radio access node. The apparatus may be in or be a central unit, a source node or a target node.

The apparatus may comprise suitable circuitry for providing the method.

Alternatively or additionally, the apparatus may comprise at least one processor and at least one memory storing instructions that, when executed by the at least one processor cause the apparatus at least to provide the method below.

Alternatively or additionally, the apparatus may be such as discussed in relation to FIG. 9.

The method may be provided by computer program code or computer executable instructions.

The method may comprise as referenced T1, receiving measurement report information provided by a communications device, the communications device using a beam associated with a cell of a target node while being connected to a source node.

The method may comprise as referenced T2 determining based on the measurement report that the communications device is to change cell to a target cell of the target node or another target node.

The method may comprise as referenced T3, causing information to be provided to the communications device of a cell change to the target cell.

It should be appreciated that the method outlined in FIG. 13 may be modified to include any of the previously described features.

Reference is made to FIG. 14 which shows a second method of some embodiments.

This method may be performed by an apparatus. The apparatus may be in or be communications device.

The apparatus may comprise suitable circuitry for providing the method.

Alternatively or additionally, the apparatus may comprise at least one processor and at least one memory storing instructions that, when executed by the at least one processor cause the apparatus at least to provide the method below.

Alternatively or additionally, the apparatus may be such as discussed in relation to FIG. 10.

The method may be provided by computer program code or computer executable instructions.

The method may comprise as referenced A1, causing a measurement report to be transmitted from a communications device, the communications device using a beam associated with a cell of a target node while being connected to a source node.

The method may comprise as referenced A2, receiving in response to the measurement report, information indicating that the communications device is to be change cell to a target cell of the target node.

It should be appreciated that the method outlined in FIG. 14 may be modified to include any of the previously described features.

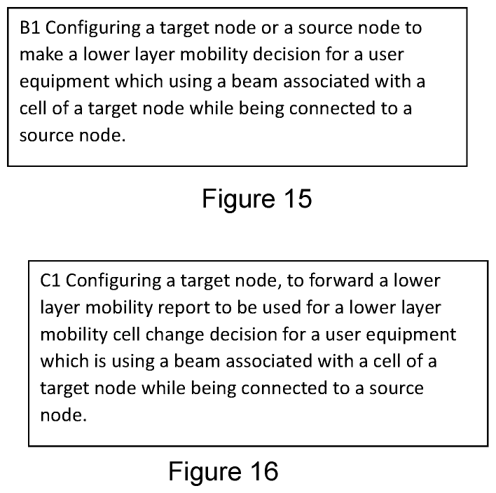

Reference is made to FIG. 15 which shows a third method of some embodiments.

This method may be performed by an apparatus. The apparatus may be provided in a radio access node. The apparatus may be in or be a central unit.

The apparatus may comprise suitable circuitry for providing the method.

Alternatively or additionally, the apparatus may comprise at least one processor and at least one memory storing instructions that, when executed by the at least one processor cause the apparatus at least to provide the method below.

Alternatively or additionally, the apparatus may be such as discussed in relation to FIG. 9.

The method may be provided by computer program code or computer executable instructions.

The method may comprise as referenced B1, configuring, by a central unit, a target node or a source node to make a lower layer mobility decision for a user equipment which using a beam associated with a cell of a target node while being connected to a source node.

It should be appreciated that the method outlined in FIG. 15 may be modified to include any of the previously described features.

Reference is made to FIG. 16 which shows a fourth method of some embodiments.

This method may be performed by an apparatus. The apparatus may be provided in a radio access node. The apparatus may be in or be a central unit.

The apparatus may comprise suitable circuitry for providing the method.

Alternatively or additionally, the apparatus may comprise at least one processor and at least one memory storing instructions that, when executed by the at least one processor cause the apparatus at least to provide the method below.

Alternatively or additionally, the apparatus may be such as discussed in relation to FIG. 9.

The method may be provided by computer program code or computer executable instructions.

The method may comprise as referenced C1, configuring a target node, to forward a lower layer mobility report to be used for a lower layer mobility cell change decision for a user equipment which is using a beam associated with a cell of a target node while being connected to a source node.

It should be appreciated that the method outlined in FIG. 16 may be modified to include any of the previously described features.

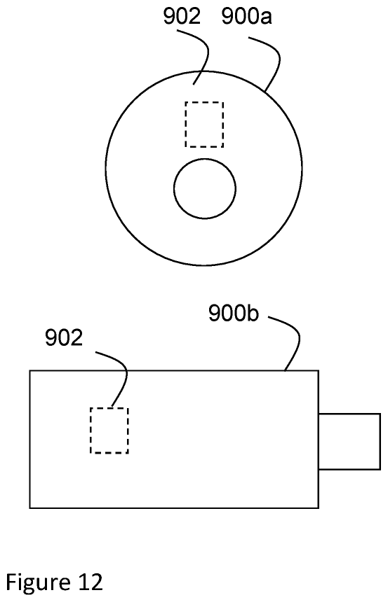

FIG. 12 shows a schematic representation of non-volatile memory media 900a or 900b storing instructions and/or parameters which when executed by a processor allow the processor to perform one or more of the steps of the methods of any of the embodiments. The non-volatile memory media may be a computer disc (CD), or digital versatile disc (DVD) schematically referenced 900a or a universal serial bus (USB) memory stick schematically referenced 900b. The computer instructions or code may be downloaded and stored in one or more memories. The memory media may store instructions and/or parameters 902 which when executed by a processor allow the processor to perform one or more of the steps of the methods of embodiments. Computer program code may be downloaded and stored in one or more memories of the device.

It is noted that while the above describes example embodiments, there are several variations and modifications which may be made to the disclosed solution without departing from the scope of the present invention.

Therefore, although certain embodiments were described above by way of example with reference to certain example architectures for wireless networks, technologies and standards, embodiments may be applied to any other suitable forms of communication systems than those illustrated and described herein.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may comprise one or more of general-purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the claims. The embodiments and features, if any, described in this specification that do not fall under the scope of the claims are to be interpreted as examples useful for understanding various embodiments of the disclosure.

It should be noted that different claims with differing claim scope may be pursued in related applications such as divisional or continuation applications.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. An apparatus comprising:
at least one processor; and
at least one memory storing instructions that, when executed by the at least one processor cause the apparatus at least to perform:
receiving measurement report information provided by a communications device, the communications device using a beam associated with a cell of a target node while being connected to a source node;
determining based on the measurement report that the communications device is to change cell to a target cell of the target node or another target node; and
causing information to be provided to the communications device of a cell change to the target cell, wherein the information comprises an indication of a lower layer mobility.

2. The apparatus as claimed in claim 1, wherein the measurement report comprises an L1 measurement report.

3. (canceled)

4. The apparatus as claimed in claim 1, caused to perform: receiving, from a central unit, lower layer mobility configuration information.

5. The apparatus as claimed in claim 1, caused to perform: causing information about the determining to be provided to a central unit.

6. The apparatus as claimed in claim 1, wherein the receiving comprises receiving the measurement report information from the communications device in the target node, the determining comprises determining in the target node that the communications device is to change cell, and the causing information to be provided to the communications device comprises causing that information to be transmitted from the target node to the communications device.

7. The apparatus as claimed in claim 1, wherein said apparatus is in or provided by the target node.

8-15. (canceled)

16. The apparatus as claimed in claim 1, wherein the communications device when using a beam associated with a target cell while being connected to a source cell is operating in an inter cell beam management mode.

17. The apparatus as claimed in claim 1, wherein the target node and the source node are distributed units of a radio access node.

18. (canceled)

19. An apparatus comprising:
at least one processor; and
at least one memory storing instructions that, when executed by the at least one processor cause the apparatus at least to perform:
causing a measurement report to be transmitted from a communications device to a target node, the communications device using a beam associated with a cell of the target node while being connected to a source node; and
receiving from the target node in response to the measurement report, information indicating that the communications device is to be change cell to a target cell of the target node, wherein the information comprises an indication of a lower layer mobility.

20. The apparatus as claimed in claim 19, wherein the measurement report comprises an L1 measurement report.

21. (canceled)

22. The apparatus as claimed in claim 19, wherein the communications device when using a beam associated with a target cell while being connected to a source cell is operating in an inter cell beam management mode.

23. The apparatus as claimed in claim 19, caused to perform: providing information to a network node indicating that the communications device is configured to support switching from an inter cell beam management mode operation to a lower layer mobility cell change operation without disconnecting inter cell beam management mode operation.

24. The apparatus as claimed in claim 19, caused to perform: providing information to a network node indicating that the communications device is configured to support coexistence of inter cell beam management and lower layer mobility.

25-27. (canceled)

28. A method comprising:
causing, by a communication device, a measurement report to be transmitted from the communications device to a target node, the communications device using a beam associated with a cell of the target node while being connected to a source node; and
receiving, by the communication device from the target node in response to the measurement report, information indicating that the communications device is to be change cell to a target cell of the target node, wherein the information comprises an indication of a lower layer mobility.

29. The method as claimed in claim 28, wherein the measurement report comprises an L1 measurement report.

30. The method as claimed in claim 28, wherein the communications device when using a beam associated with a target cell while being connected to a source cell is operating in an inter cell beam management mode.

31-33. (canceled)
